(19) United States
(12) Patent Application Publication
(10) Pub. No.: US 2009/0236480 A1
(43) Pub. Date: Sep. 24, 2009

(54) ROTARY DEVICE

(75) Inventor: Jin-Shi Lai, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/406,081

(22) Filed: Mar. 17, 2009

(30) Foreign Application Priority Data
Mar. 21, 2008 (CN) 200810300663.X

(51) Int. Cl. A47B 96/06; F16B 43/00

(52) U.S. Cl. 248/206.5; 16/2.1

(57) ABSTRACT

A rotary device includes a first member, a second member, a first magnetic body secured to the first member, and a second magnetic body corresponding to the first magnetic body and secured to the second member. Corresponding surfaces of the first and second magnetic bodies have different polarities.

### BACKGROUND

1. Technical Field

Embodiments of the present disclosure generally relate to rotary devices, and particularly to a rotary device having a rotary mechanism.

2. Description of Related Art

Commonly, a rotary device includes a first member, a second member, and a hinge connecting the first member to the second member. The hinge is often composed of resilient members and cams. The first member is thus rotatable with respect to the second member. However, restoring forces of the resilient members may be weakened after repeatedly rotating the first member with respect to the second member, thus the reliability of the rotary device decreases with use.

Therefore, improved rotary devices are needed to address the aforementioned deficiencies and inadequacies.

### BRIEF DESCRIPTION OF THE DRAWINGS

FIG. 1 is an isometric view of a rotary device in accordance with an exemplary embodiment.

FIG. 2 is a partially exploded view of the rotary device in FIG. 1.

FIG. 3 is an exploded view of the rotary device in FIG. 1 from one direction.

FIG. 4 is an exploded view of the rotary device in FIG. 1 from a reverse direction to FIG. 3.

FIG. 5 is an isometric view of the rotary device in FIG. 1 in a rotated state.

### DETAILED DESCRIPTION OF EXEMPLARY EMBODIMENTS

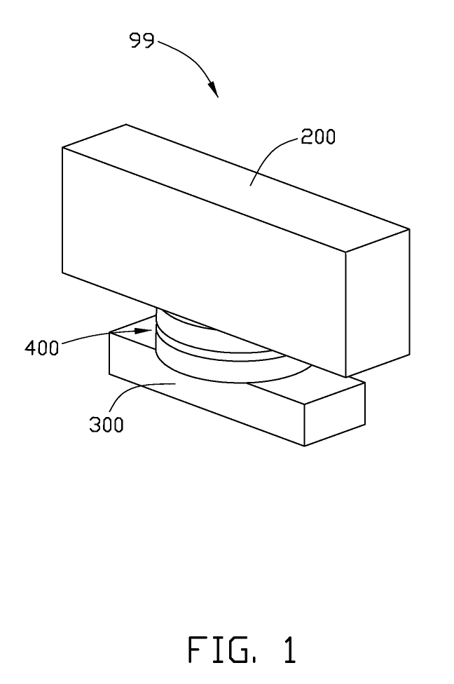

Referring to FIG. 1, a rotary device 99, for example, a display device, includes a first member 200, a second member 300, and a rotary mechanism 400. The rotary mechanism 400 rotatablely connects the first member 200 to the second member 300, thus the first member 200 is rotatable with respect to the second member 300.

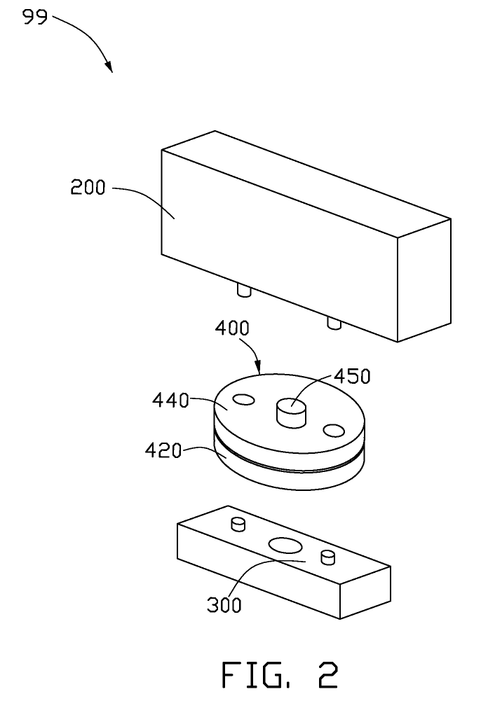

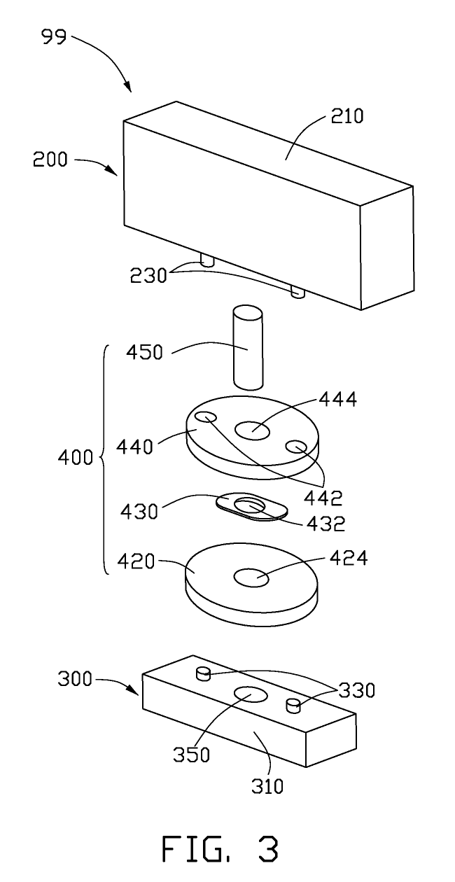

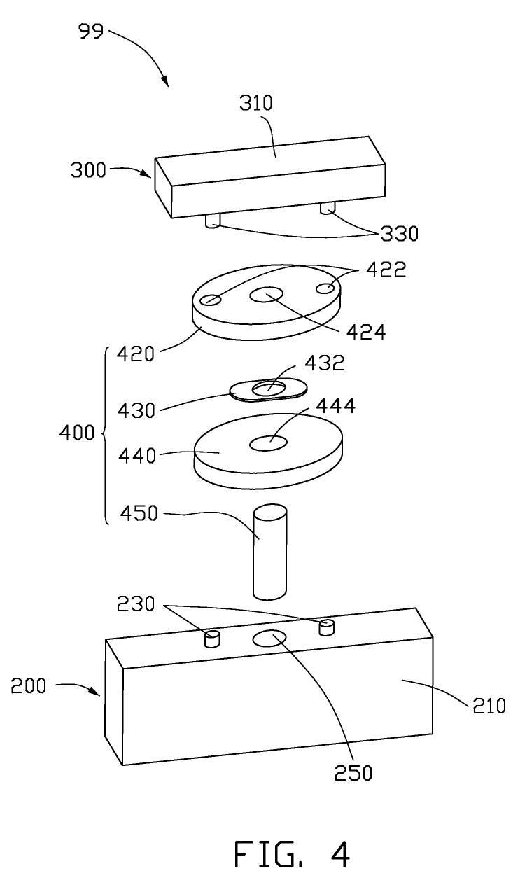

Referring to FIGS. 2 to 4, the first member 200 includes a main body 210, two first protruding posts 230 perpendicularly connected with the main body 210. A first mounting hole 250 is defined in the main body 210 and between the two first protruding posts 230.

The second member 300 is similar with the first member 200. The second member 300 includes a base portion 310, two second protruding posts 330 substantially perpendicular to the base portion 310. A second mounting hole 350 is defined in the base portion 310 and between the two second protruding posts 330.

The rotary mechanism 400 includes a shaft 450, a first magnetic body 440, a washer 430, and a second magnetic body 420. The shaft 450 is cylindrical and the two ends of the shaft 450 are configured to be rotatably inserted into the first mounting hole 250 and the second mounting hole 350 correspondingly, thus the first member 200 is rotatable with respect to the second member 300. The first magnetic body 440, the washer 430, and the second magnetic body 420 are sleeved on the shaft 450. The washer 430 is sandwiched between the magnetic bodies 440, 420.

The first magnetic body 440 is disk-shaped and attached to the first member 200. The first magnetic body 440 defines two fixing holes 442 configured for engageably receiving the first protruding posts 230, correspondingly, as a result the first magnetic body 440 can be fastened to the first member 200, and rotating the first member 200 drives the first magnetic body 440 to rotate. A through hole 444 is defined in the first magnetic body 440 and between the two fixing holes 442 for allowing the shaft 450 to pass through the first magnetic body 440.

The second magnetic body 420 is disk-shaped and attached to the second member 300. The second magnetic body 420 defines two fixing holes 422 configured for engageably receiving the two second protruding posts 330 correspondingly, as a result the second magnetic body 420 can be fastened to the second member 300. A through hole 424 is defined in the second magnetic body 420 and between the two fixing holes 422 for allowing the shaft 450 to pass through the second magnetic body 420. Corresponding surfaces of the first magnetic body 440 and the second magnetic body 420 have different polarities.

The washer 430 defines a through hole 432 configured for allowing the shaft 450 to pass through.

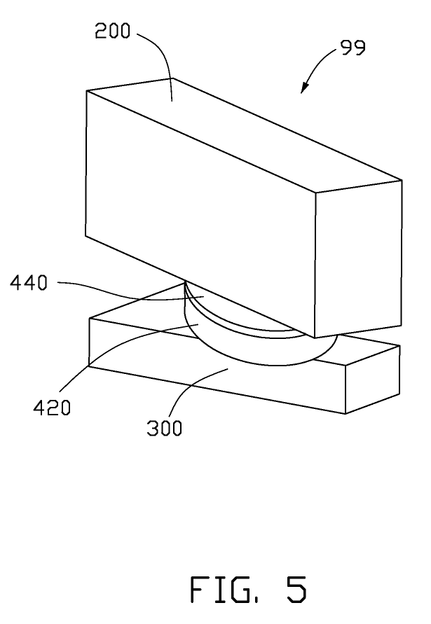

In use, an external rotating force is applied to the first member 200, as a result the first member 200 will drive the first magnetic body 440 to rotate clockwise or counter-clockwise to any angle (referring to FIG. 5) with respect to the second magnetic body 420. Corresponding surfaces of the first magnetic body 440 and the second magnetic body 420 having different polarities can generate an attractive magnetic force between the first magnetic body 440 and the second magnetic body 420, thus the first magnetic body 440 and the first member 200 are stably stopped when the external force is released. In addition, the first magnetic body 440 and the second magnetic body 420 are still functional after repetitious use. Therefore, the reliability of the rotary device 99 is improved.

Moreover, the washer 430 sandwiched between the first magnetic body 440 and the second magnetic body 420 can decrease friction between the first magnetic body 440 and the second magnetic body 420 when the first member 200 rotates with respect to the second member 300. Therefore, the reliability and work life of the rotary device 99 are further improved.

It is to be understood, however, that even though numerous information and advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. A rotary device comprising:
a first member;
a second member;
a first magnetic body fastened to the first member; and
a second magnetic body corresponding to the first magnetic body and fastened to the second member, and corresponding surfaces of the first and second magnetic bodies having different polarities.

2. The rotary device according to claim 1, wherein the rotary device further comprises a washer sandwiched between the first magnetic body and the second magnetic body.

3. The rotary device according to claim 1, wherein the first member comprises a protruding post, and the first magnetic body defines a fixing hole configured for engageably receiving the protruding post.

4. The rotary device according to claim 1, wherein the second member comprise a protruding post, and the second magnetic body defines a fixing hole configured for engageably receiving the protruding post.

5. The rotary device according to claim 1, wherein the rotary device further comprises a shaft with two ends being rotatablely inserted into the first member and the second member correspondingly, and the first magnetic body and the second magnetic body are sleeved on the shaft.

6. The rotary device according to claim 1, wherein the first magnetic body is disk-shaped.

7. The rotary device according to claim 1, wherein the second magnetic body is disk-shaped.

8. A rotary device comprising:
a first member;
a second member with respect to which the first member is capable of rotating when an external force for rotating the first member is exerted on the first member;
a first magnetic body secured to the first member; and
a second magnetic body corresponding to the first magnetic body and secured to the second member, and corresponding surfaces of the first and second magnetic bodies having polarities that generates a magnetic force for stopping the first magnetic body and the first member when the external force is released.

9. The rotary device according to claim 8, wherein the rotary device further comprises a washer sandwiched between the first magnetic body and the second magnetic body.

10. The rotary device according to claim 8, wherein the rotary device further comprises a shaft with two ends being rotatablely inserted into the first member and the second member correspondingly, and the first magnetic body and the second magnetic body are sleeved on the shaft.

11. The rotary device according to claim 8, wherein the first magnetic body is disk-shaped.

12. The rotary device according to claim 8, wherein the second magnetic body is disk-shaped.

13. A rotary device comprising:
a first member; and
a second member magnetically and rotatablely connected with the first member by a magnetic force, and the first member being capable of rotating via an external force and stopping via the magnetic force when the external force is released with respect to the second member.

14. The rotary device according to claim 13, wherein the rotary device further comprises a rotary mechanism rotatablely connecting the first member to the second member, and the magnetic force provided by the rotary mechanism.

15. The rotary device according to claim 14, wherein the rotary mechanism comprising:
a first magnetic body secured to the first member; and
a second magnetic body corresponding to the first magnetic body and secured to the second member, and corresponding surfaces of the first and second magnetic bodies having different polarities to generate an attractive magnetic force.

16. The rotary device according to claim 15, wherein the rotary mechanism further comprises a washer sandwiched between the first magnetic body and the second magnetic body.

17. The rotary device according to claim 15, wherein the first member comprises a protruding post, and the first magnetic body defines a fixing hole configured for engageably receiving the protruding post.

18. The rotary device according to claim 15, wherein the rotary device further comprises a shaft with two ends being rotatablely inserted into the first member and the second member correspondingly, and the first magnetic body and the second magnetic body are sleeved on the shaft.

19. The rotary device according to claim 15, wherein the first magnetic body is disk-shaped.

20. The rotary device according to claim 15, wherein the second magnetic body is disk-shaped.
